(19) United States
(12) Patent Application Publication
(10) Pub. No.: US 2015/0117172 A1
(43) Pub. Date: Apr. 30, 2015

(54) OPTICAL PICKUP

(71) Applicant: Hitachi-LG Data Storage, Inc., Tokyo (JP)

(72) Inventors: Tatsuya YAMASAKI, Tokyo (JP); Katsuhiko KIMURA, Tokyo (JP); Ryuichiro MIZUNO, Tokyo (JP)

(73) Assignee: Hitachi-LG Data Storage, Inc.

(21) Appl. No.: 14/527,990

(22) Filed: Oct. 30, 2014

(30) Foreign Application Priority Data
Oct. 30, 2013 (JP) 2013-225898

(51) Int. Cl. G11B 7/1392

(52) U.S. Cl. CPC G11B 7/13927
USPC 369/44.14

(57) ABSTRACT

An optical pickup includes a pair of first tracking coils near the center of the lens holder in the tracking direction on one side of the holder; a pair of first magnets facing the first tracking coils and near the outer sides of the holder in the tracking direction; a pair of second tracking coils near the outer sides of the holder on another side of the holder; and a pair of second magnets facing the second tracking coils and near the center of the holder. The vertical electromagnetic force F in each of the first tracking coils is larger than the vertical electromagnetic force f in each of the second tracking coils. A distance K between the action center of the force F and the support center of the movable part is shorter than a distance k between the action center of the force f and the support center.

### CLAIM OF PRIORITY

The present application claims priority from Japanese Patent Application JP 2013-225898 filed on Oct. 30, 2013, the content of which is hereby incorporated by reference into this application.

### FIELD OF THE INVENTION

The present invention relates to an optical pickup that reads information recorded on a recording surface of an optical disc and writes information onto the recording surface.

### BACKGROUND OF THE INVENTION

In an optical pickup, tilt of an object lens, which causes optical aberration and expands a focus spot, will prevent accurate write of information into a disc or lead to degradation of a read signal. Optical pickups have been proposed having a structure for suppressing the tilt of the object lens. For example, Japanese Unexamined Patent Application Publication No. 2004-171662 (JP2004-171662) discloses “an object lens drive unit including an object lens focusing light onto a recording surface of an optical disc, a lens holder holding the object lens, focusing coils and tracking coils fixed to the lens holder, a plurality of support members that movably support a movable part having the lens holder in focusing and tracking directions with respect to a stationary part, a yoke component formed of a magnetic material, and a plurality of magnets disposed on two lateral sides of the movable part parallel to the tracking direction, wherein the magnets on a first lateral side of the movable part parallel to the tracking direction are disposed on two end sides of the movable part, and the magnets on a second lateral side of the movable part parallel to the tracking direction are disposed near the center of the movable part.”

In the configuration disclosed in JP 2004-171662, the magnets are disposed on two end sides of the movable part on the first lateral side of the movable part parallel to the tracking direction, and the magnets are disposed near the center of the movable part on the second lateral side of the movable part parallel to the tracking direction, thereby a direction of the moment generated in a tracking coil disposed on the first lateral side of the movable part is opposite to a direction of the moment generated in a tracking coil disposed on the second lateral side thereof. In this configuration, the magnets are asymmetrically disposed on the first lateral side and on the second lateral side. Hence, such a drive unit tends to have a large external shape. Alternatively, if the drive unit is controlled to have a traditional size, distances from the action center of the electromagnetic force generated in each of the tracking coils to the support center of the movable part are different between on the first lateral side and the second lateral side of the movable part, so that the moments cannot be completely cancelled with each other.

An object of the invention is to provide an optical pickup having a movable part with a small tilt angle even in a configuration where distances from the action center of the electromagnetic force generated in each of the tracking coils to the support center of a movable part are different between on the first lateral side and on the second lateral side.

### SUMMARY OF THE INVENTION

To solve the above-described problem, one aspect of the present invention has the following configuration. An optical pickup of the present invention is configured to move an object lens in a focusing direction and in a tracking direction, the object lens focusing light onto a recording surface of an optical disc. The optical pickup comprises a lens holder fixed to a stationary part with support members and holding the object lens, the lens holder having a first side face parallel to the tracking direction and a second side face parallel to the tracking direction; a pair of first tracking coils disposed near a center of the lens holder in the tracking direction on the first side face of the lens holder; a pair of second tracking coils disposed near outer sides of the lens holder in the tracking direction on the second side face of the lens holder; a pair of first magnets disposed in a position to face the first tracking coils, respectively, and be near the outer sides of the lens holder in the tracking direction; and a pair of second magnets disposed in a position to face the second tracking coils, respectively, and be near the center of the lens holder in the tracking direction, wherein, when a direction from the object lens to the optical disc along a light axis of the object lens is defined to be an upward direction, a distance K between an action center of vertical electromagnetic force generated in each of the first tracking coils and a support center as a balance center of stiffness of the support members is shorter than a distance k between an action center of vertical electromagnetic force generated in each of the second tracking coils and the support center, and the vertical electromagnetic force F generated in each of the first tracking coils is larger than the vertical electromagnetic force f generated in each of the second tracking coils.

According to the invention, even in a configuration where a distance from the action center of the electromagnetic force generated in each of the tracking coils to the support center of the movable part is different between on the first lateral side and the second lateral side of the movable part, it is possible to reduce the moment generated in the tracking coils during movement of the object lens. Hence, an optical pickup can be achieved with the object lens having a small tilt angle.

### BRIEF DESCRIPTION OF THE DRAWINGS

FIG. 1 illustrates an optical pickup according to one embodiment of the invention;

FIG. 2 is an exploded perspective view illustrating a configuration of an object lens drive unit in an optical pickup according to a first embodiment;

FIG. 3 is a top view of the object lens drive unit;

FIG. 4 is a side view of the object lens drive unit;

FIG. 5A is a schematic illustration of the electromagnetic forces generated in the tracking coils (when the movable part is at the neutral position), illustrating a view showing a projection of the first magnets and the first tracking coils onto the yz plane;

FIG. 5B is a schematic illustration of the electromagnetic forces generated in the tracking coils (when the movable part is at the neutral position), illustrating a view showing a projection of the second magnets and the second tracking coils onto the yz plane;

FIG. 6A is a schematic illustration of the electromagnetic forces generated in the tracking coils (when the movable part is moved), illustrating a view showing a projection of the first magnets and the first tracking coils onto the yz plane;

FIG. 6B is a schematic illustration of the electromagnetic forces generated in the tracking coils (when the movable part is moved), illustrating a view showing a projection of the second magnets and the second tracking coils onto the yz plane;

FIG. 7 is a top view of an object lens drive unit in an optical pickup according to a second embodiment;

FIG. 8A is a schematic illustration of the electromagnetic forces generated in the tracking coils (when the movable part is at the neutral position), illustrating a view showing a projection of the first magnets and the first tracking coils onto the yz plane;

FIG. 8B is a schematic illustration of the electromagnetic forces generated in the tracking coils (when the movable part is at the neutral position), illustrating a view showing a projection of the second magnets and the second tracking coils onto the yz plane;

FIG. 9A is a schematic illustration of the electromagnetic forces generated in the tracking coils (when the movable part is at the neutral position) in a third embodiment, illustrating a view showing a projection of the first magnets and the first tracking coils onto the yz plane;

FIG. 9B is a schematic illustration of the electromagnetic forces generated in the tracking coils (when the movable part is at the neutral position) in the third embodiment, illustrating a view showing a projection of the second magnets and the second tracking coils onto the yz plane; and

FIG. 10A is a schematic illustration of the electromagnetic forces generated in the tracking coils (when the movable part is at the neutral position) in a fourth embodiment, illustrating a view showing a projection of the first magnets and the first tracking coils onto the yz plane;

FIG. 10B is a schematic illustration of the electromagnetic forces generated in the tracking coils (when the movable part is at the neutral position) in the fourth embodiment, illustrating a view showing a projection of the second magnets and the second tracking coils onto the yz plane.

### DETAILED DESCRIPTION OF THE PREFERRED EMBODIMENTS

Embodiments of the present invention are described with accompanying drawings.

### First Embodiment

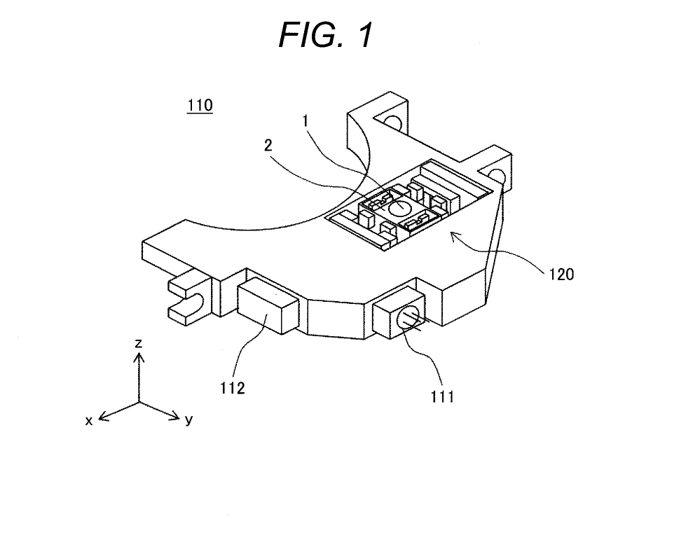

FIG. 1 illustrates an optical pickup according to one embodiment of the invention. An optical pickup 110 includes a laser light emitting device 111, a photodetector 112, and an object lens drive unit 120. Laser light emitted by the light emitting device 111 is focused on an optical disc (not depicted in FIG. 1) by an object lens 1 and reflected by the optical disc. The laser light reflected by the optical disc passes through the object lens 1 and enters the photodetector 112 in the optical pickup 110. A servo signal is detected from a signal provided by the photodetector 112, and a drive current is applied to focusing coils and tracking coils of the object lens drive unit 120 based on the servo signal to perform positioning-control of the object lens 1. In addition, a read signal is detected from the signal provided by the photodetector 112 to read information in the optical disc. Designing the object lens drive unit 120 as follows achieves an optical pickup having an object lens with a small tilt angle.

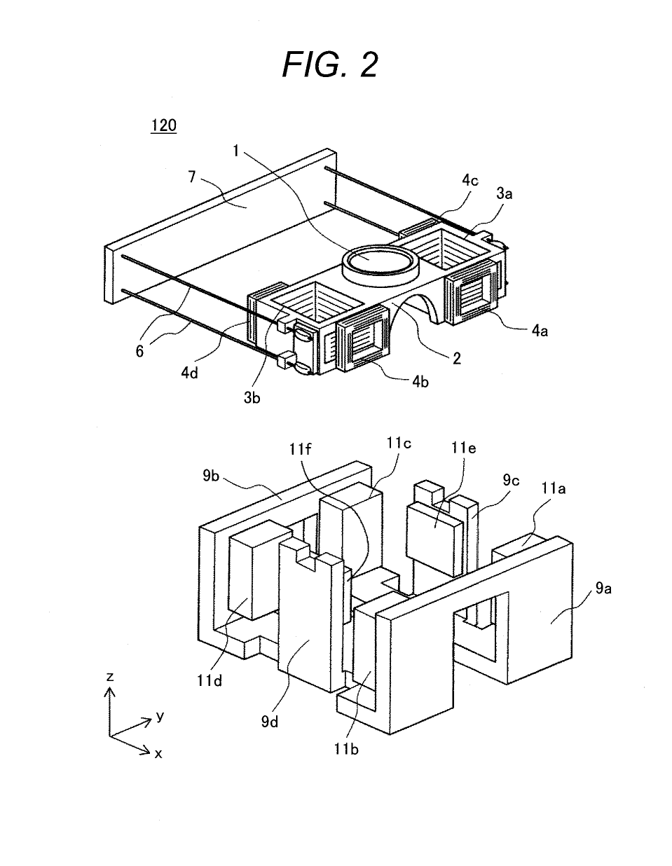

FIG. 2 is an exploded perspective view illustrating a configuration of an object lens drive unit 120 according to a first embodiment. In the drawings, an x-axis direction is a tangent direction of the optical disc (not depicted in FIG. 2), a y-axis direction is a tracking direction as a radial direction of the optical disc, and a z-axis direction is a focusing direction as a light axis direction of the object lens 1.

A lens holder 2 holding the object lens 1 is equipped with focusing coils 3a and 3b as drive coils, a pair of first tracking coils 4a and 4b, and a pair of second tracking coils 4c and 4d. Each of conductive wire-shaped support members 6 has a first end fixed to a stationary part 7 and a second end fixed to the lens holder 2. A movable part is configured of the lens holder 2 to which the object lens 1, the focusing coils 3a and 3b, the first tracking coils 4a and 4b, and the second tracking coils 4c and 4d are fixed.

First magnets 11a, 11b and second magnets 11c, 11d, each having a magnetization direction corresponding to the x-axis direction in the drawings, are attached and fixed to outer yokes 9a and 9b, respectively, as yoke components formed of a magnetic material. Inner yokes 9c and 9d, which are a pair, are disposed in the inside of the focusing coils 3a and 3b, respectively, at positions substantially perpendicular to the outer yokes 9a and 9b. The inner yokes 9c and 9d are each formed by folding an end portion of a bottom plate of a yoke component 9. Third magnets 11e and 11f, each having a magnetization direction corresponding to the y-axis direction in the drawings, are disposed on the respective facing surfaces of the inner yokes 9c and 9d. A magnetic circuit with high magnetic efficiency is formed by the outer yokes 9a, 9b, the inner yokes 9c, 9d, the first magnets 11a, 11b, the second magnets 11c, 11d, and the third magnets 11e, 11f.

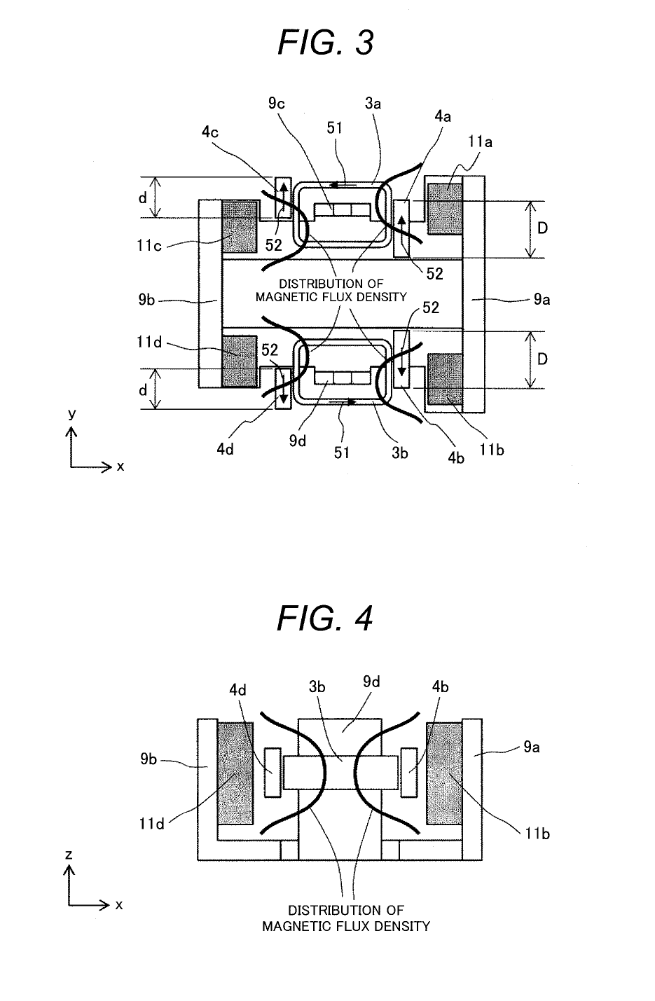

FIG. 3 is a top view of the object lens drive unit 120. FIG. 4 is a side view of the object lens drive unit 120. In FIGS. 3 and 4, the focusing coils 3a, 3b, the first tracking coils 4a, 4b, the second tracking coils 4c, 4d, the outer yokes 9a, 9b, the inner yokes 9c, 9d, the first magnets 11a, 11b, and the second magnets 11c, 11d are shown as major internal components of the object lens drive unit 120. Arrangements of the first magnets 11a, 11b, the second magnets 11c, 11d, the first tracking coils 4a, 4b, and the second tracking coils 4c, 4d are now described.

As illustrated in FIGS. 2 and 3, the first magnets 11a, 11b are each disposed near outer sides of the lens holder 2 in the tracking direction (y direction) on a first lateral side (on the right side in each drawing) of the lens holder 2 parallel to the tracking direction. The second magnets 11c and 11d are each disposed near the center of the lens holder 2 in the tracking direction on a second lateral side (on the left side in each drawing) of the lens holder 2.

On the first lateral side of the lens holder 2, each of the first tracking coils 4a and 4b is disposed near the center of the lens holder 2 in the tracking direction with respect to each of the first magnets 11a and 11b. On the second lateral side of the lens holder 2, each of the second tracking coils 4c and 4d is disposed near the outer sides of the lens holder 2 in the tracking direction with respect to each of the second magnets 11c and 11d. In other words, the first magnets 11a and 11b face coil windings near outer sides of the first tracking coils 4a and 4b, respectively, and the second magnets 11c and 11d face coil windings near inner sides of the second tracking coils 4c and 4d, respectively.

Furthermore, in the first embodiment, the length D in the tracking direction (y direction) of each of the first tracking coils 4a and 4b is larger than the length d in the tracking direction of each of the second tracking coils 4c and 4d (D>d).

In the object lens drive unit 120 configured as above, distribution of magnetic flux density generated from each magnet is shown in the top view of FIG. 3 (distribution in the y-direction) and in the side view of FIG. 4 (distribution in the z direction). Specifically, the magnetic flux density has a component in the x direction, which is largest in the center of each magnet and smaller at a position closer to the periphery of the magnet.

The polarity of each of the magnets 11a to 11d is defined to be the N pole on a side facing the lens holder 2 and to be the S pole on a side close to the outer yokes 9a and 9b. When a current 51 is applied to each of the focusing coils 3a and 3b in the arrow direction illustrated in FIG. 3, the electromagnetic force in the z direction is generated in each of the focusing coils 3a and 3b, and a movable part is moved in the z direction as the focusing direction. When a current 52 is applied to each of the tracking coils 4a to 4d in the arrow direction illustrated in FIG. 3, force in the y direction is generated in each of the tracking coils 4a to 4d, and the movable part is moved in the y direction as the tracking direction.

Furthermore, the y-directional component of the current 52 flowing through each of the tracking coils 4a to 4d causes forces that move the movable part in the z direction. If the forces in the z direction are not balanced, the movable part is tilted. In the first embodiment, the length D in the tracking direction of each of the first tracking coils 4a and 4b is larger than the length d in the tracking direction of each of the second tracking coils 4c and 4d, thereby the electromagnetic force in the z direction generated in each of the first tracking coils 4a and 4b is different from that generated in each of the second tracking coils 4c and 4d. In addition, as described above, each of facing positions between the first magnets 11a, 11b and the first tracking coils 4a, 4b is displaced in the y direction from each of facing positions between the second magnets 11c and 11d and the second tracking coils 4c and 4d. In other words, a distance from the action center of the z-axial electromagnetic force generated in the tracking coil to the support center of the movable part is different between on the first lateral side and on the second lateral side. In this configuration, combining the difference in the electromagnetic force and the difference in distance to the action center cancels the moment generated in the movable part and suppress tilt of the movable part.

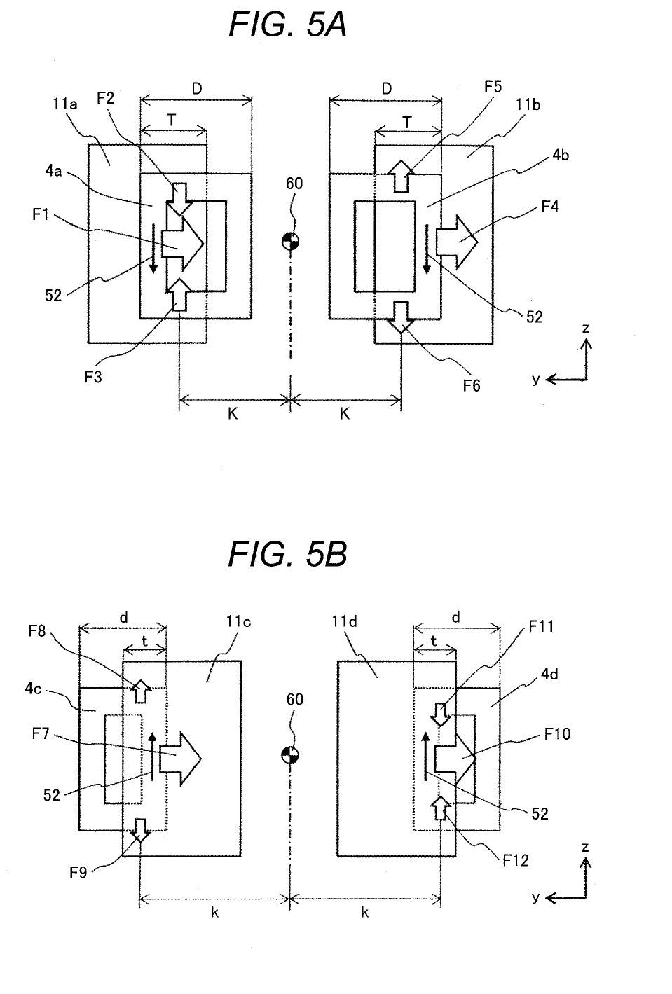

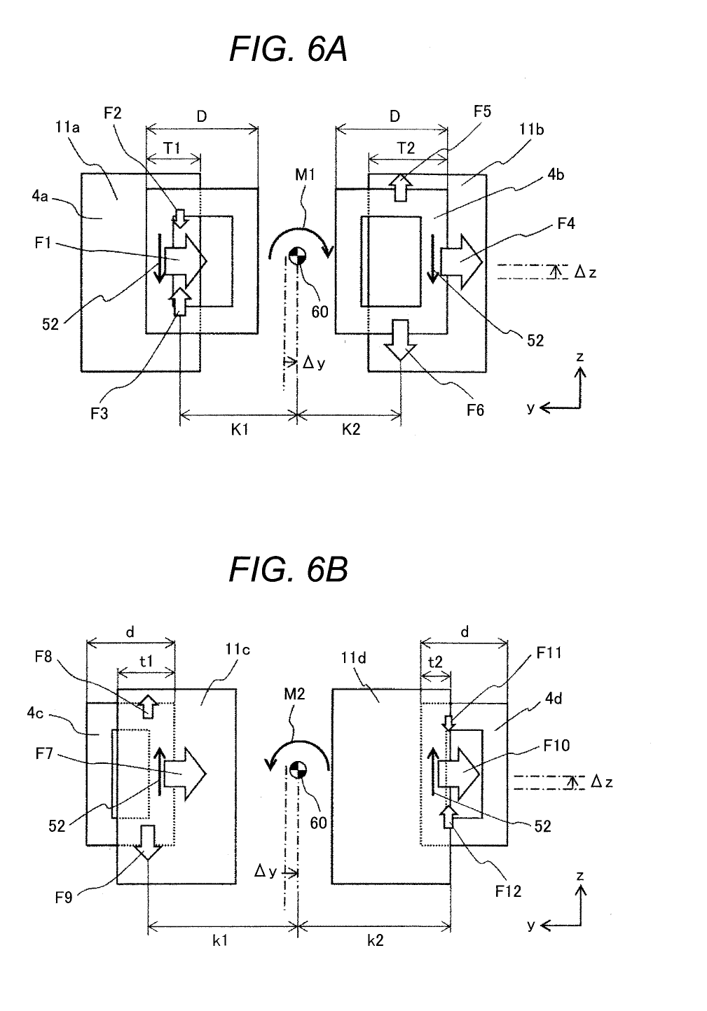

Operation of the object lens drive unit 120 in the first embodiment is now described in detail with FIGS. 5A, 5B, 6A and 6B.

FIGS. 5A and 5B are schematic illustrations of the electromagnetic forces generated in the tracking coils when the movable part is at the neutral position. FIG. 5A is a view showing a projection of the first magnets 11a and 11b and the first tracking coils 4a and 4b onto the yz plane, and FIG. 5B is a view showing a projection of the second magnets 11c and 11d and the second tracking coils 4c and 4d onto the yz plane.

The length D in the tracking direction of each of the first tracking coils 4a and 4b is larger than the length d in the tracking direction of each of the second tracking coils 4c and 4d. Consequently, when the movable part is at the neutral position, length T in the tracking direction of a region in which the first tracking coils 4a and 4b face the first magnets 11a and 11b, respectively, is larger than length t in the tracking direction of a region in which the second tracking coils 4c and 4d face the second magnets 11c and 11d, respectively. All of the first tracking coils 4a and 4b and the second tracking coils 4c and 4d have the same number of turns.

As illustrated in FIGS. 5A and 5B, when currents 52 having the same magnitudes are applied to the first tracking coils 4a and 4b and the second tracking coils 4c and 4d in the arrow directions, the electromagnetic forces F1 and F4 in the tracking direction (y direction) are generated in the first tracking coils 4a and 4b, respectively, and the electromagnetic forces F7 and F10 in the tracking direction are generated in the second tracking coils 4c and 4d, respectively. Moreover, the vertical (z-axial) electromagnetic forces F2 and F5 are generated in upper sides of the first tracking coils 4a and 4b, respectively, and the vertical electromagnetic forces F3 and F6 are generated in lower sides thereof, respectively. In addition, the vertical electromagnetic forces F8 and F11 are generated in upper sides of the second tracking coils 4c and 4d, respectively, and the vertical electromagnetic forces F9 and F12 are generated in lower sides thereof, respectively.

Among them, the vertical electromagnetic forces F2, F5, F8, F11, F3, F6, F9, and F12 generated in the portions of the first tracking coils 4a and 4b and the second tracking coils 4c and 4d cause tilt of the movable part. Magnitude of each of such electromagnetic forces is represented by a product of magnitude of a current, magnetic flux density affecting each coil, the number of turns of the coil, and the length (facing length) in the tracking direction of a region in which the coil faces the magnet. In the first embodiment, all of the applied currents have the same magnitude and all of the coils have the same number of turns. The same magnetic flux density is generated in each coil when the movable part is at the neutral position. As a result, a difference in the electromagnetic force is exclusively determined by the facing length of the coil to the magnet. With the facing length in the tracking direction of the region in which the coil faces the magnet, facing length T of each of the first tracking coils 4a and 4b is larger than facing length t of each of the second tracking coils 4c and 4d. Hence, the vertical electromagnetic forces F2, F3, F5, and F6 generated in the first tracking coils 4a and 4b are larger than the vertical electromagnetic forces F8, F9, F11, and F12 generated in the second tracking coils 4c and 4d.

A distance is denoted as K in the tracking direction from the support center 60 as the balance center of stiffness of the support members 6 to the action center of each of the electromagnetic forces F2, F3, F5, and F6, and a distance is denoted as kin the tracking direction from the support center 60 to the action center of each of the electromagnetic forces F8, F9, F11, and F12. As described above, the first tracking coils 4a and 4b are disposed near the center of the lens holder 2 in the tracking direction, and the second tracking coils 4c and 4d are disposed near the outer sides of the lens holder 2 in the tracking direction, resulting in a relationship K<k.

The moment that acts on each of portions (on upper and lower sides) of each of the first and second tracking coils is represented by a product of the electromagnetic force and arm length (the distance from the support center 60 to the action center). The moment acting on each portion of each first tracking coil is in proportion to the product of T and K, and the moment acting on each portion of each second tracking coil is in proportion to the product of t and k. Due to the relationships of T>t and K<k, a difference between the two moments is small and, if a condition T·K=t·k is satisfied, the two moments are equal to each other. When the movable part is at the neutral position as in FIGS. 5A and 5B, the vertical electromagnetic forces generated in the upper and lower sides corresponding to each other of each of the first and second tracking coils have directions opposite to each other and have values equal to each other (for example, F2=F3 and F8=F9). Hence, the moment M1 of the whole first tracking coils and the moment M2 of the whole second tracking coils are both 0. Consequently, the movable part is not tilted when the movable part is at the neutral position.

Although each of the moments M1 and M2 is not 0 when the movable part is moved, the moments can be cancelled with each other due to the above-described conditions, i.e., the relationship in the facing length of the tracking coil to the magnet (T>t) and the relationship in distance from the support center to the action center of the electromagnetic force (K<k). This is now described.

FIGS. 6A and 6B are schematic illustrations of the electromagnetic forces generated in each tracking coil when the movable part is moved. FIG. 6A is a view showing a projection of the first magnets 11a and 11b and the first tracking coils 4a and 4b onto the yz plane, and FIG. 6B is a view showing a projection of the second magnets 11c and 11d and the second tracking coils 4c and 4d onto the yz plane. FIGS. 6A and 68 illustrate a state where the movable part is moved by the electromagnetic force generated in each coil, in which a moving distance in the tracking direction is denoted as Δy and a moving distance in the focusing direction is denoted as Δz.

When the movable part is moved by Δz in the focusing direction, the movable part is affected by variations in distribution of magnetic flux density illustrated in FIG. 4, and thereby the electromagnetic forces generated in the lower sides of the first tracking coils 4a and 4b and the second tracking coils 4c and 4d become larger than the electromagnetic forces generated in the upper sides thereof. When the movable part is moved by Δy in the tracking direction, the facing length T and t of the tracking coil to the magnet is changed to T1, T2 and t1, t2, respectively, resulting in a difference in the electromagnetic force generated between the first tracking coils 4a and 4b and between the second tracking coils 4c and 4d. When the movable part is moved by Δy in the tracking direction, the distance K and k from the support center to the action center of the electromagnetic force is changed into K1, K2 and k1, k2, respectively. As a result, the moments M1 and M2 around the x axis with respect to the support center 60 are generated. The electromagnetic forces and the moments generated in such a case will be represented by computational equations below.

The number of turns of each of the tracking coils 4a to 4d is denoted as n, the magnetic flux density affecting each of the upper and lower sides of the tracking coils 4a to 4d is denoted as B, and the current is denoted as i. In FIGS. 6A and 6B, the respective facing lengths of the tracking coils to the magnets are changed to T1=T−Δy, T2=T+Δy, t1=t+Δy, and t2=t−Δy. The respective distances from the support center to the action centers of the electromagnetic force are changed to K1=K+α, K2=K−α, k1=k+α, and k2=k−α. The magnetic flux density affecting the upper side of each of the tracking coils 4a to 4d is changed to B−ΔB, and the magnetic flux density affecting the lower side thereof is changed to B+ΔB. Accordingly, the electromagnetic forces F2, F3, F5, and F6 generated in the first tracking coils 4a and 4b are represented by the following equations:

F2=i(B−ΔB)n(T−Δy)

F3=i(B+ΔB)n(T−Δy)

F5=i(B−ΔB)n(T+Δy)

F6=i(B+ΔB)n(T+Δy).

The magnitude M1 of the moment generated in the tracking coils 4a and 4b is represented by the following equation:

M1=−(K+α)F2+(K+α)F3−(K−α)F5+(K−α)F6.

From these equations, M1 is represented by the following equation:

M1=4iΔBnTK−4iΔBnαΔy.

Similarly, the magnitude M2 of the moment generated in the second tracking coils 4c and 4d is represented by the following equation:

M2=4iΔBntK+4iΔBnαΔy.

The differential moment (M1−M2) causing tilt of the movable part is represented by the following equation:

M1−M2=4iΔBn(TK−tk)−4iΔBnαΔy.

Since the second term in the right-hand side is negligibly small, a condition TK=tk should be satisfied to achieve M1−M2=0. In other words, T/t=k/K should be satisfied, and when the lengths D and t of the tracking coils are accordingly set, an optical pickup having a movable part with a small tilt angle can be provided.

To describe the above-described condition in a different way, when the distance from the support center to the action center of the electromagnetic force varies, the electromagnetic forces acting on the individual tracking coils should be differently set such that a ratio of the electromagnetic force is inverse of a ratio of the arm length.

Although the two magnets 11c and 11d are disposed as the second magnets in the first embodiment, the two magnets may be connected into one second magnet. In the first embodiment, as illustrated in FIG. 2, the first tracking coils 4a and 4b and the first magnets 11a and 11b are disposed on a side away from the stationary part 7, and the second tracking coils 4c and 4d and the second magnets 11c and 11d are disposed on a side close to the stationary part 7. Similar effects can be provided from a configuration where such components are reversely disposed regarding the distance from the stationary part 7.

### Second Embodiment

An optical pickup according to a second embodiment of the present invention has a configuration in which the moments are cancelled by making the lengths of the first and second magnets different from each other.

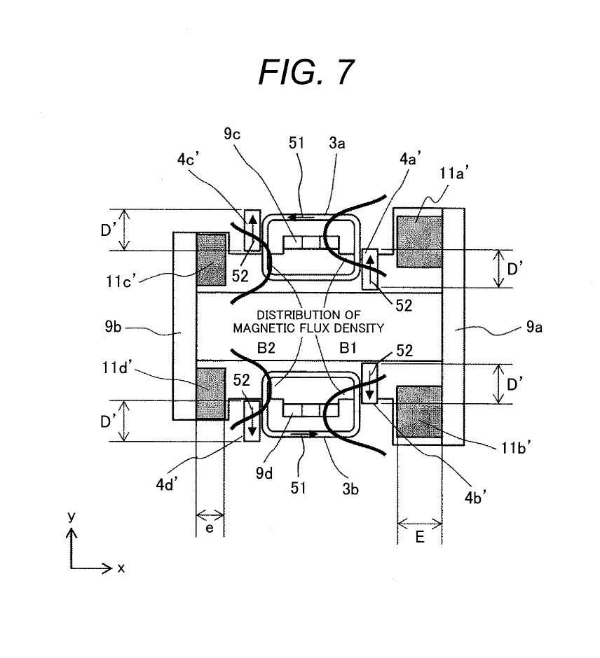

FIG. 7 is a top view of an object lens drive unit 120 in an optical pickup according to the second embodiment. The second embodiment is different from the first embodiment (FIG. 3) in respective dimensions of the first tracking coils 4a′ and 4b′, the second tracking coils 4c′ and 4d′, the first magnets 11a′ and 11b′, and the second magnets 11c′ and 11d′. The length D′ in the tracking direction of each of the first tracking coils 4a′ and 4b′ is equal to the length D′ in the tracking direction of each of the second tracking coils 4c′ and 4d′. The length E in the x direction (magnetization direction) of each of the first magnets 11a′ and 11b′ is larger than the length e in the x direction of each of the second magnets 11c′ and 11d′ (E>e). Consequently, the magnetic flux density B1 generated from the first magnets 11a′ and 11b′ is larger than the magnetic flux density B2 generated from the second magnets 11c′ and 11d′ (B1>B2). The first tracking coils 4a′ and 4b′ and the second tracking coils 4c′ and 4d′ all have the same number of turns. In addition, magnitudes of applied currents to the first tracking coils 4a′ and 4b′ and the second tracking coils 4c′ and 4d′ are all the same.

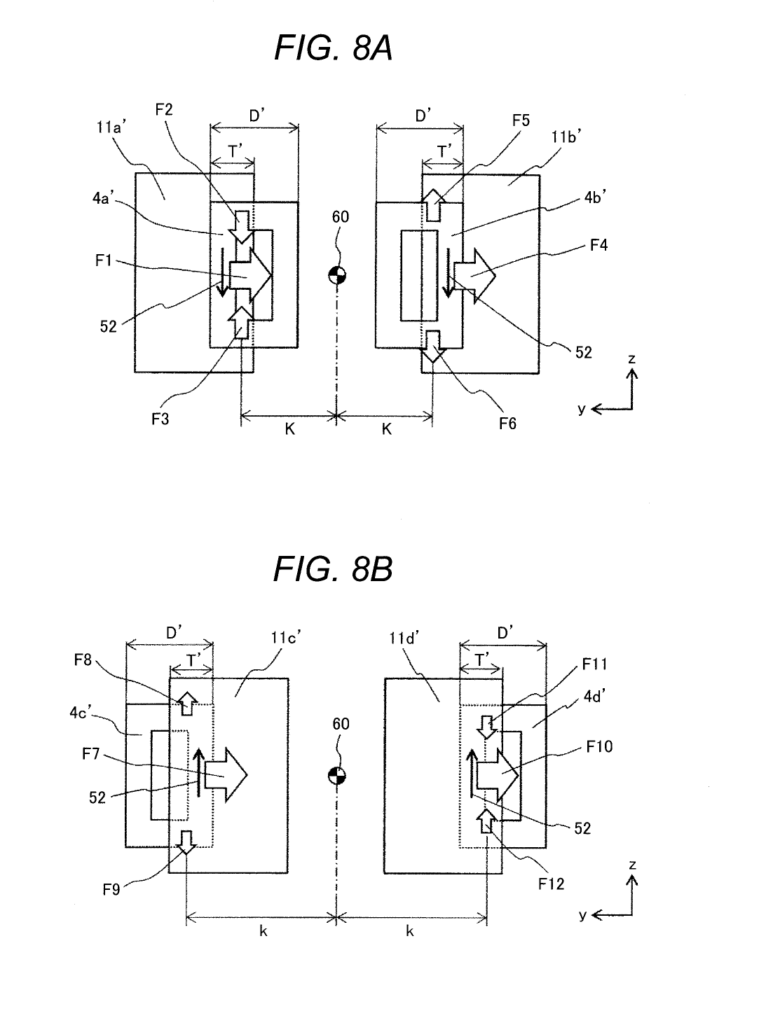

FIGS. 8A and 8B are schematic illustrations of the electromagnetic forces generated in the tracking coils when the movable part is at the neutral position. FIG. 8A is a view showing a projection of the first magnets 11a′ and 11b′ and the first tracking coils 4a′ and 4b′ onto the yz plane. FIG. 8B is a view showing a projection of the second magnets 11c′ and 11d′ and the second tracking coils 4c′ and 4d′ onto the yz plane. The facing lengths of the first and second tracking coils to the magnets are all equal to each other, i.e., are equal to T′.

Due to the above-described magnitude relationship in magnetic flux density (B1>B2), the vertical electromagnetic forces F2, F3, F5, and F6 generated in the first tracking coils 4a′ and 4b′ are larger than the vertical electromagnetic forces F8, F9, F11, and F12 generated in the second tracking coils 4c′ and 4d′. The distances in the tracking direction from the support center 60 to the action centers of the electromagnetic force are in a relationship of K<k as in the first embodiment.

The moment that acts on each of portions of the first and second tracking coils is represented by a product of the electromagnetic force and the distance to the action center. The moment that acts on each portion of each first tracking coil is in proportion to the product of B1 and K, and the moment that acts on each portion of each second tracking coil is in proportion to the product of B2 and k. Due to the relationships of B1>B2 and K<k, a difference between the two moments is small and, if a condition B1·K=B2·k is satisfied, the two moments are equal to each other.

In such a state, it is assumed that the movable part is moved by Δy in the tracking direction and by Δz in the focusing direction. In this case, the difference (T>t) in facing length of the tracking coil to the magnet in the first embodiment is replaced with a difference (B1>B2) in magnetic flux density generated from the magnet, thereby making it possible to obtain the electromagnetic force and the moment generated in each tracking coil. As a result, it is understood that the moments generated in the first and second tracking coils are cancelled with each other, and a condition B1·K=B2·k should be satisfied to control a difference between the moments to be 0, i.e., to achieve M1−M2=0. In other words, the respective lengths E and e of the first and second magnets should be set such that a ratio of the magnetic flux density satisfies B1/B2=k/K. This also means that the electromagnetic forces acting on the individual tracking coils are differently set such that a ratio of the electromagnetic force is inverse of a ratio of the arm length.

According to the second embodiment, the length E in the x direction of each of the first magnets 11a′ and 11b′ is larger than the length e in the x direction of each of the second magnets 11c′ and 11d′, and thereby an optical pickup having a movable part with a small tilt angle can be provided.

Moreover, since coils having the same dimensions can be used for both the first tracking coils 4a′, 4b′ and the second tracking coils 4c′, 4d′, the movable part is good in mass balance in the x direction. Therefore, it is possible to provide an optical pickup having a movable part with a small angle of tilt caused by imbalance in mass.

### Third Embodiment

An optical pickup according to a third embodiment of the present invention has a configuration in which the moments are cancelled by making currents applied to the first and second tracking coils different from each other.

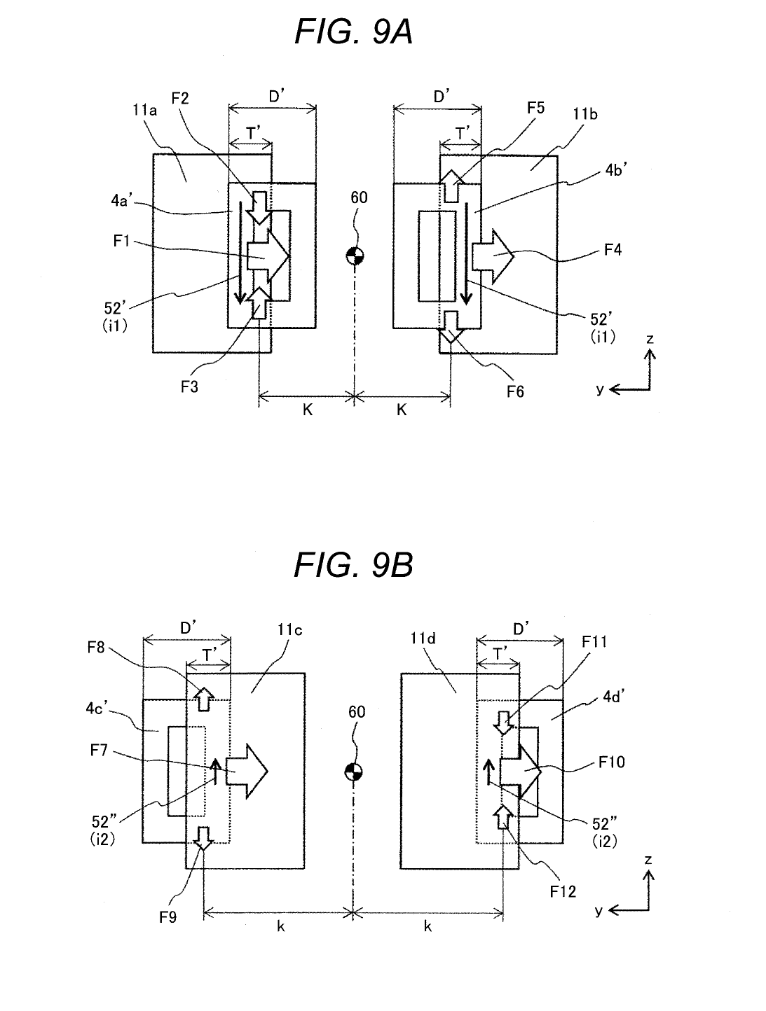

FIGS. 9A and 9B are schematic illustrations of the electromagnetic forces generated in the tracking coils when the movable part is at the neutral position in the third embodiment. FIG. 9A is a view showing a projection of the first magnets 11a and 11b and the first tracking coils 4a′ and 4b′ onto the yz plane. FIG. 9B is a view showing a projection of the second magnets 11c and 11d and the second tracking coils 4c′ and 4d′ onto the yz plane.

The third embodiment is different from the first embodiment (FIGS. 5A and 5B) in dimensions of the first tracking coils 4a′ and 4b′ and the second tracking coils 4c′ and 4d′, current 52′ (=i1) applied to the first tracking coils, and current 52″ (=i2) applied to the second tracking coils. The first tracking coils 4a′ and 4b′ and the second tracking coils 4c′ and 4d′ all have the same number of turns.

The length D′ in the tracking direction of each of the first tracking coils 4a′ and 4b′ is equal to the length D′ in the tracking direction of each of the second tracking coils 4c′ and 4d′. As a result, the facing lengths (indicated by T′) of the tracking coils to the magnets are equal to each other. The magnitude of the current 52′ (i1) is larger than the magnitude of the current 52″ (i2) (i1>i2). Consequently, the vertical electromagnetic forces F2, F3, F5, and F6 generated in the first tracking coils 4a′ and 4b′ are larger than the vertical electromagnetic forces F8, F9, F11, and F12 generated in the second tracking coils 4c′ and 4d′. The distances in the tracking direction from the support center 60 to the action centers of the electromagnetic force are in a relationship of K<k as in the first embodiment.

The moment acting on each portion of each first tracking coil is in proportion to the product of i1 and K, and the moment acting on each portion of each second tracking coil is in proportion to the product of i2 and k. Due to the relationships of i1>i2 and K<k, a difference between the two moments is small and, if a condition i1·K=i2·k is satisfied, the two moments are equal to each other.

In such a state, it is assumed that the movable part is moved by Δy in the tracking direction and by Δz in the focusing direction. In this case, the difference (T>t) in facing length of the tracking coil to the magnet in the first embodiment is replaced with a difference (i1>i2) in current applied to the tracking coil, thereby making it possible to obtain the electromagnetic force and the moment generated in each tracking coil. As a result, it is understood that the moments generated in the first and second tracking coils are cancelled with each other, and a condition i1·K=i2·k should be satisfied to control a difference between the moments to be 0, i.e., to achieve M1−M2=0. In other words, the currents should be set such that a ratio of the applied current satisfies i1/i2=k/K.

According to the third embodiment, the current applied to the first tracking coils 4a′ and 4b′ is larger than the current applied to the second tracking coils 4c′ and 4d′, and thereby an optical pickup having a movable part with a small tilt angle can be provided.

Moreover, since coils having the same dimensions can be used for both the first tracking coils 4a′, 4b′ and the second tracking coils 4c′, 4d′, the movable part is good in mass balance in the x direction. Therefore, it is possible to provide an optical pickup having a movable part with a small angle of tilt caused by imbalance in mass. Furthermore, the technique in the third embodiment is advantageous in that the optical pickup (object lens drive unit) is adjustable even after it is assembled since the technique includes varying a current applied to each coil.

### Fourth Embodiment

An optical pickup according to a fourth embodiment of the present invention has a configuration in which the moments are cancelled by making the number of turns of the first and second tracking coils different from each other.

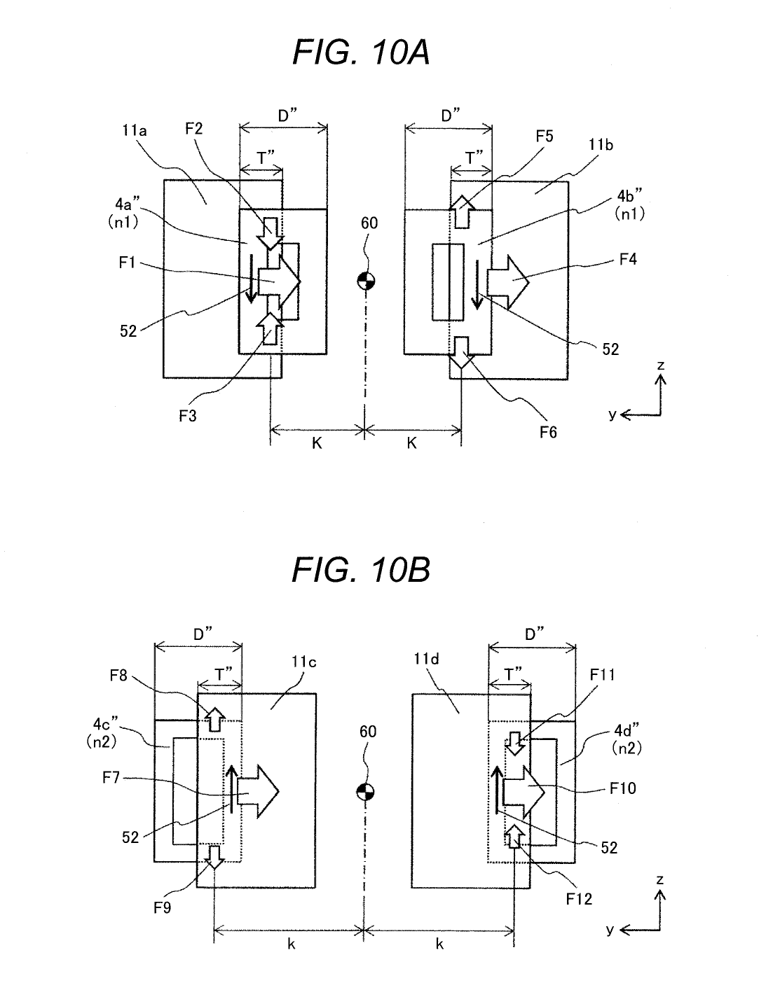

FIGS. 10A and 10B are schematic illustrations of the electromagnetic forces generated in the tracking coils when the movable part is at the neutral position in the fourth embodiment. FIG. 10A is a view showing a projection of the first magnets 11a and 11b and the first tracking coils 4a″ and 4b″ onto the yz plane. FIG. 10B is a view showing a projection of the second magnets 11c and 11d and the second tracking coils 4c″ and 4d″ onto the yz plane.

The fourth embodiment is different from the first embodiment (FIGS. 5A and 5B) in dimensions and number of turns (n1 and n2) of the tracking coils 4a″ to 4d″. The magnitude of a current 52 applied to the first tracking coils 4a″ and 4b″ is equal to the magnitude of a current 52 applied to the second tracking coils 4c″ and 4d″.

The length D″ in the tracking direction of each of the first tracking coils 4a″ and 4b″ is equal to the length D″ in the tracking direction of each of the second tracking coils 4c″ and 4d″. As a result, the facing lengths (indicated by T″) of the tracking coils to the magnets are equal to each other. Moreover, the number of turns (n1) of each of the first tracking coils 4a″ and 4b″ is larger than the number of turns (n2) of each of the second tracking coils 4c″ and 4d″ (n1>n2). Consequently, the vertical electromagnetic forces F2, F3, F5, and F6 generated in the first tracking coils 4a″ and 4b″ are larger than the vertical electromagnetic forces F8, F9, F11, and F12 generated in the second tracking coils 4c″ and 4d″. The distances in the tracking direction from the support center 60 to the action centers of the electromagnetic force are in a relationship of K<k as in the first embodiment.

The moment acting on each portion of each first tracking coil is in proportion to the product of n1 and K, and the moment acting on each portion of each second tracking coil is in proportion to the product of n2 and k. Due to the relationships of n1>n2 and K<k, a difference between the two moments is small and, if a condition n1·K=n2·k is satisfied, the two moments are equal to each other.

In such a state, it is assumed that the movable part is moved by Δy in the tracking direction and by Δz in the focusing direction. In this case, the difference (T>t) in facing length of the tracking coil to the magnet in the first embodiment is replaced with a difference (n1>n2) in number of turns of the tracking coil, thereby making it possible to obtain the electromagnetic force and the moment generated in each tracking coil. As a result, it is understood that the moments generated in the first and second tracking coils are cancelled with each other, and a condition n1·K=n2·k should be satisfied to control a difference between the moments to be 0, i.e., to achieve M1−M2=0. In other words, the number of turns should be set such that a ratio of the number of turns satisfies n1/n2=k/K.

According to the fourth embodiment, the number of turns of each of the first tracking coils 4a″ and 4b″ is larger than the number of turns of each of the second tracking coils 4c″ and 4d″, and thereby an optical pickup having a movable part with a small tilt angle can be provided.

Embodiments of the present invention have been described hereinbefore. The invention is not limited to the configurations in the embodiments and includes various modifications thereof. For example, while the above-described embodiments have been described in detail for ease in understanding of the invention, the invention is not necessarily limited to aspects having all the configurations described in the embodiments. In addition, part of a configuration of an embodiment may be replaced with a configuration of another embodiment. Furthermore, a configuration of an embodiment may be additionally provided with a configuration of another embodiment. In addition, part of a configuration of each embodiment may be additionally provided with a configuration of another embodiment, omitted, or replaced with a configuration of another embodiment.

### DESCRIPTION OF THE REFERENCE CHARACTERS

1 . . . object lens
2 . . . lens holder
3a, 3b . . . focusing coil
4a, 4b . . . first tracking coil
4c, 4d . . . second tracking coil
6 . . . support members
7 . . . stationary part
9a, 9b . . . outer yoke
9c, 9d . . . inner yoke
11a, 11b . . . first magnet
11c, 11d . . . second magnet
11e, 11f . . . third magnet
51 . . . current applied to focusing coil
52 . . . current applied to tracking coil
60 . . . support center
110 . . . optical pickup
111 . . . laser light emitting device
112 . . . photodetector
120 . . . object lens drive unit
D . . . length of first tracking coil
d . . . length of second tracking coil
T . . . facing length of first tracking coil to first magnet
t . . . facing length of second tracking coil to second magnet
K . . . distance from support center to action center of electromagnetic force of first tracking coil
k . . . distance from support center to action center of electromagnetic force of second tracking coil
M1 . . . moment caused by first tracking coil
M2 . . . moment caused by second tracking coil

What is claimed is:

1. An optical pickup configured to move an object lens in a focusing direction and in a tracking direction, the object lens focusing light onto a recording surface of an optical disc, the optical pickup comprising:
a lens holder fixed to a stationary part with support members and holding the object lens, the lens holder having a first side face parallel to the tracking direction and a second side face parallel to the tracking direction;
a pair of first tracking coils disposed near a center of the lens holder in the tracking direction on the first side face of the lens holder;
a pair of second tracking coils disposed near outer sides of the lens holder in the tracking direction on the second side face of the lens holder;
a pair of first magnets disposed in a position to face the first tracking coils, respectively, and be near the outer sides of the lens holder in the tracking direction; and
a pair of second magnets disposed in a position to face the second tracking coils, respectively, and be near the center of the lens holder in the tracking direction,
wherein, when a direction from the object lens to the optical disc along a light axis of the object lens is defined to be an upward direction, a distance K between an action center of vertical electromagnetic force generated in each of the first tracking coils and a support center as a balance center of stiffness of the support members is shorter than a distance k between an action center of vertical electromagnetic force generated in each of the second tracking coils and the support center, and
the vertical electromagnetic force F generated in each of the first tracking coils is larger than the vertical electromagnetic force f generated in each of the second tracking coils.

2. The optical pickup according to claim 1,
wherein the electromagnetic forces F and f and the distances K and k are in a relationship of F/f=k/K.

3. The optical pickup according to claim 1,
wherein a length D in the tracking direction of each of the first tracking coils is larger than a length d in the tracking direction of each of the second tracking coils.

4. The optical pickup according to claim 1,
Wherein, when a direction perpendicular to both of the focusing direction and the tracking direction is defined to be x direction, a length E of each of the first magnets in the x direction is larger than a length e of each of the second magnets in the x direction.

5. The optical pickup according to claim 1,
wherein a current i1 applied to each of the first tracking coils is larger than a current i2 applied to each of the second tracking coils.

6. The optical pickup according to claim 1,
wherein the number of turns n1 of each of the first tracking coils is larger than the number of turns n2 of each of the second tracking coils.
